(19) United States
(12) Patent Application Publication
(10) Pub. No.: US 2026/0292542 A1
(43) Pub. Date: Sep. 24, 2026

(54) SYSTEM AND METHOD FOR INTELLIGENT RECOMMENDATION SYSTEM FOR INTENT ORCHESTRATION IN WIRELESS NETWORKS

(71) Applicant: Telefonaktiebolaget LM Ericsson (publ), Stockholm (SE)

(72) Inventors: Md Arafat HABIB, Gatineau (CA); Hao ZHOU, Ottawa (CA); Pedro Enrique ITURRIA RIVERA, Ottawa (CA); Melike EROL-KANTARCI, Ottawa (CA); Medhat ELSAYED, Nepean (CA); Majid BAVAND, Ottawa (CA); Raimundas GAIGALAS, Hässelby (SE); Yigit OZCAN, Gloucester (CA)

(21) Appl. No.: 19/473,722

(22) PCT Filed: Apr. 10, 2024
(86) PCT No.: PCT/IB2024/053513

§ 371 Date: Oct. 8, 2025

Related U.S. Application Data
(60) Provisional application No. 63/496,303, filed on Apr. 14, 2023.

(51) Int. Cl. H04W 24/02; H04L 41/16; H04L 41/5009

(52) U.S. Cl. CPC H04W 24/02; H04L 41/16; H04L 41/5009

(57) ABSTRACT

A method, and network node for intelligent recommendation for intent orchestration in wireless networks are disclosed. According to one aspect, a method in a network node includes receiving operational intents from a plurality of network operators, the operational intents including a plurality of conflicting desired results to be achieved by the network, the operational intents being expressed in a natural language. The method includes mapping the operational intents to a plurality of network goals of an artificial intelligence, AI, process. The method includes determining, based at least in part on an output of the AI process, a combination of network features to achieve an optimization of network performance network node the plurality of network goals, the optimization involving a tradeoff between the plurality of conflicting desired results.

### FIELD

The present disclosure relates to wireless communications, and in particular, to intelligent recommendation for intent orchestration in wireless networks.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WDs) or user equipments (UEs), as well as communication between network nodes and between UEs. The 3GPP is also developing standards for Sixth Generation (6G) wireless communication networks.

The emergence of 5G networks has drawn the attention of researchers to conduct artificial intelligence (AI)-based network optimization to provide end users with the desired performances. Next generation networks may allow operators to configure their networks using intents that look more like the natural language than setting certain parameters in vendor-provided interfaces. However, multiple intents and objectives identified by an operator may result in conflicting parameter settings or decisions that would degrade the performance, although the intention of the operator is improving the performance of the network and providing better quality of service (QoS) to the end users. In particular, when the operator intents are fulfilled with multiple network functions, each network function implemented on a different platform may require orchestration. As a result of orchestration, some of the operator intents may need to be modified to address conflicts or performance degradation, or ping-pong effects. This may require a recommendation system that directs operator intents towards wholistic optimization goals that would configure the network in the highest performing way. However, it is quite challenging to design a system that may support multiple traffic classes in the network by maintaining each of their stringent QoS requirements. Also, the increased number of users with densely deployed network nodes may make it even harder to optimize 5G NR in non-stand-alone (NSA) mode with dual connectivity (DC). Known optimization approaches are highly concentrated on some particular key performance indicators (KPIs). However, increasing one parameter might severely affect others. For example, a traffic steering approach works on multiple radio access technology (multi-RAT) environments to maintain the QoS requirements of different traffic types. This increases performance in terms of delay and throughput. However, it ignores maintaining energy efficiency. Another example may be given from the perspective of advanced cell sleeping mechanisms, where significant efforts have been made to optimize energy efficiency in the network while ignoring other key KPIs.

### SUMMARY

Some embodiments advantageously provide methods, systems, and apparatuses for intelligent recommendation for intent orchestration in wireless networks.

Existing approaches do not emphasize optimization goals with multiple tradeoffs and, therefore, ignore the fact that focusing on one parameter may significantly affect many other perspectives or parameters.

The above-described problems with existing approaches may be solved by building a platform with multiple network functions dedicated to improving certain KPIs having constraints of the other performance metrics. In a system with multiple network functions, there may be a question from the operator's perspective as to which network function to invoke, e.g., if a certain network function is invoked, what might that eventually optimize, and to what extent. This may be relevant if the invoked network function may achieve the desired performance increase, satisfying the need of the network operator. Scenarios may get much more complicated when there are multiple network functions working to optimize highly dense 5G deployments. This leads to a situation where it might be desirable to develop an artificially intelligent (AI) recommendation system that may provide suggestions regarding which network functions and configurations may lead to the desired performance. Once the system is trained with enough data, it may be able to provide accurate recommendations to the operators. This may alleviate the need to performing heavy-weight optimization each time the operator wants a performance increase.

Some approaches have concerned systems on the wireless device side that may provide recommendations regarding which network node to connect to. However, existing approaches do not include recommending intents based on a KPI provided as by an operator. Such intents may be, e.g., a collection of desired results and objectives that a network is to accomplish, defined in a declarative way, without outlining the methods for achieving or carrying them out. Generally, the recommendation system described herein might be categorized as intent-based networking and may facilitate autonomous network management for future cellular networks.

Due to the growth of the networks and multiple traffic types, numerous network functions from diverse vendors may be involved in the system. Existing approaches are unable to provide recommendations at the network operator level regarding how intents should be orchestrated and the underlying network functions to be selected to meet a desired performance increase.

Existing approaches that focus on specific KPIs without addressing how others may be effective lack considerations for the goals and trade-offs. However, consideration of conflicting goals may be used to optimize the wireless network in different ways. Thus, a recommender system may provide an operator with available options and the potential outcomes.

The present disclosure relates to a recommendation system for wireless networks with diverse radio access technologies having multiple network functions. A recommendation system for a network operator to select appropriate network functions and configurations in the system for a desired performance increase is described. The performance increase relates to increasing a key performance indicator, and it may also maintain QoS requirements associated with multiple traffic types.

Advantages of embodiments described herein may include one or more of the following:
Simplifying network optimization process by an assistive AI-based technology that is used to orchestrate operator intents where the intents may be acting on a single vendor-supplied hardware or software or multiple vendor-supplied resources;
Development of a recommendation system that may provide the network operator suggestions regarding which network functions and configurations may be opted for reaching the desired performance increase;
The recommendation system may be independent of the underlying reinforcement learning algorithms used to build the network functions and their management. Once the dataset has been built, the recommendation system may operate independently for providing recommendations to the network operator, thereby reducing the computation overhead of running underlying optimization algorithms in the network functions on a regular basis; and/or
Various embodiments are able to deal with abstract goals that may not be immediately identified as optimization goals without human translation. Goals from the operator may be, e.g., reducing 10% energy consumption or increasing performance by 15% throughput. Also, some embodiments may provide an answer to the question that what happens when these goals with trade-offs co-exist with each other and how to best optimize the performance.

According to one aspect, a method in a network node configured to control a network for communications with a plurality of user equipments, UEs, is provided. The method includes receiving operational intents from a plurality of network operators, the operational intents including a plurality of conflicting desired results to be achieved by the network, the operational intents being expressed in a natural language. The method includes mapping the operational intents to a plurality of network goals of an artificial intelligence, AI, process. The method also includes determining, based at least in part on an output of the AI process, a combination of network features to achieve an optimization of network performance network node (16) the plurality of network goals, the optimization involving a tradeoff between the plurality of conflicting desired results.

According to this aspect, in some embodiments, the network goals include decreasing energy consumption compared to an existing energy consumption and increasing throughput compared to an existing throughput. In some embodiments, the method includes determining an expected performance from execution of the combination of network features and communicating the expected performance to at least one network operator of the plurality of network operators. In some embodiments, determining a combination of network features includes determining a combination of network features that results in a highest level of performance among different combinations of network features, as measured by at least one key performance indicator, KPI. In some embodiments, the at least one KPI is determined based at least in part on at least one of the received operational intents. In some embodiments, the method includes implementing the determined combination of network features. In some embodiments, determining the combination of network features is based at least in part on at least one of a traffic load ratio, a queue length of a base station and an indicator of quality of service, QoS, status. In some embodiments, determining the combination of network features is based at least in part on data collected from a plurality of base stations and stored in a database. In some embodiments, the database is populated with data obtained based at least in part on network performances associated with a plurality of combinations of network features. In some embodiments, determining the combination of network features includes training network application functions based at least in part on the network goals.

According to another aspect, a network node configured control a network for communications with a plurality of user equipments, UEs, is provided. The network node is configured to: receive operational intents from a plurality of network operators, the operational intents including a plurality of conflicting desired results to be achieved by the network, the operational intents being expressed in a natural language; map the operational intents to a plurality of network goals of an artificial intelligence, AI, process; and determine, based at least in part on an output of the AI process, a combination of network features to achieve an optimization of network performance network node (16) the plurality of network goals, the optimization involving a tradeoff between the plurality of conflicting desired results.

According to this aspect, in some embodiments, the network goals include decreasing energy consumption compared to an existing energy consumption and increasing throughput compared to an existing throughput. In some embodiments, the network node is configured to determine an expected performance from execution of the combination of network features and communicating the expected performance to at least one network operator of the plurality of network operators. In some embodiments, determining a combination of network features includes determining a combination of network features that results in a highest level of performance among different combinations of network features, as measured by at least one key performance indicator, KPI. In some embodiments, the at least one KPI is determined based at least in part on at least one of the received operational intents. In some embodiments, the network node is configured to implement the determined combination of network features. In some embodiments, determining the combination of network features is based at least in part on at least one of a traffic load ratio, a queue length of a base station and an indicator of quality of service, QoS, status. In some embodiments, determining the combination of network features is based at least in part on data collected from a plurality of base stations and stored in a database. In some embodiments, the database is populated with data obtained based at least in part on network performances associated with a plurality of combinations of network features. In some embodiments, determining the combination of network features includes training network application functions based at least in part on the network goals.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a management node according to some embodiments of the present disclosure;

FIG. 8 is a flowchart of an example process according to principles disclosed herein;

FIG. 9 is a diagram of an example system according to some embodiments of the present disclosure;

FIG. 10 is a diagram of an example recommendation system according to some embodiments of the present disclosure; and

FIG. 11 is a flowchart illustrating example methods according to some embodiments of the present disclosure.

### DETAILED DESCRIPTION

Before describing in detail example embodiments, it is noted that the embodiments reside primarily in combinations of apparatus components and processing steps related to intelligent recommendation for intent orchestration in wireless networks. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) or a UE or a radio network node.

In some embodiments, the non-limiting terms wireless device (WD) or a user equipment (UE) are used interchangeably. The UE herein may be any type of wireless device capable of communicating with a network node or another UE over radio signals. The UE may also be a radio communication device, target device, device to device (D2D) UE, machine type UE or UE capable of machine to machine communication (M2M), low-cost and/or low-complexity UE, a sensor equipped with UE, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B, or one or both of A and B. In some embodiments, at least one of A, B and C corresponds to one or more of A, B and C, and/or A, B, C or a combination thereof.

Note further, that functions described herein as being performed by a wireless device, a network node, or a management node may be distributed over a plurality of wireless devices, network nodes, and/or management nodes. In other words, it is contemplated that the functions of the network node, wireless device, and management node described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide intelligent recommendations for intent orchestration in wireless networks.

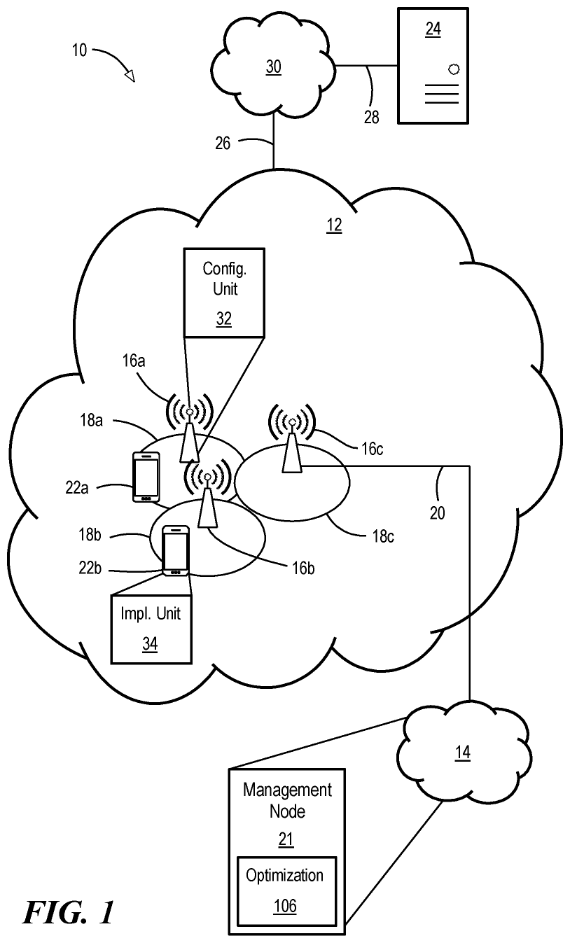

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20.

The system 10 may further include a management node 21, which may be a network node 16, such as a network node 16 which provides one or more management node 21 functionalities, a cloud-based node and/or server, etc. Management node 21 may communicate with and/or receive information (e.g., performance metrics) associated with one or more of the plurality of network nodes 16, e.g., via one or more of the access network 12, the core network 14, an internet connection, etc., and may communicate with and/or receive information associated with the plurality of network nodes 16 directly and/or via one or more intermediate devices.

A first UE 22a located in coverage area 18a is configured to wirelessly connect to, or be paged by, the corresponding network node 16a. A second UE 22b in coverage area 18b is wirelessly connectable to the corresponding network node 16b. While a plurality of UEs 22a, 22b (collectively referred to as wireless devices 22) are illustrated in this example, the disclosed embodiments are equally applicable to a situation where a sole UE is in the coverage area or where a sole UE is connecting to the corresponding network node 16. Note that although only two UEs 22 and three network nodes 16 are shown for convenience, the communication system may include many more UEs 22 and network nodes 16.

Also, it is contemplated that a UE 22 may be in simultaneous communication and/or configured to separately communicate with more than one network node 16 and more than one type of network node 16. For example, a UE 22 may have dual connectivity with a network node 16 that supports LTE and the same or a different network node 16 that supports NR. As an example, UE 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private, or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected UEs 22a, 22b and the host computer 24. The connectivity may be described as an over-the-top (OTT) connection. The host computer 24 and the connected UEs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of the routing of uplink and downlink communications. For example, a network node 16 may not or need not be informed about the past routing of an incoming downlink communication with data originating from a host computer 24 to be forwarded (e.g., handed over) to a connected UE 22a. Similarly, the network node 16 need not be aware of the future routing of an outgoing uplink communication originating from the UE 22a towards the host computer 24.

A network node 16 is configured to include a configuration unit 32, which is configured to perform one or more network node 16 functions described herein, including functions related to intelligent recommendation for intent orchestration in wireless networks. A wireless device 22 is configured to include an implementation unit 34 which is configured to perform one or more wireless device 22 functions described herein, including functions related to intelligent recommendation for intent orchestration in wireless networks. A management node 21 includes an optimization unit 106, which is configured to perform one or more management node 21 functions disclosed herein, such as intelligent recommendation for intent orchestration in wireless networks.

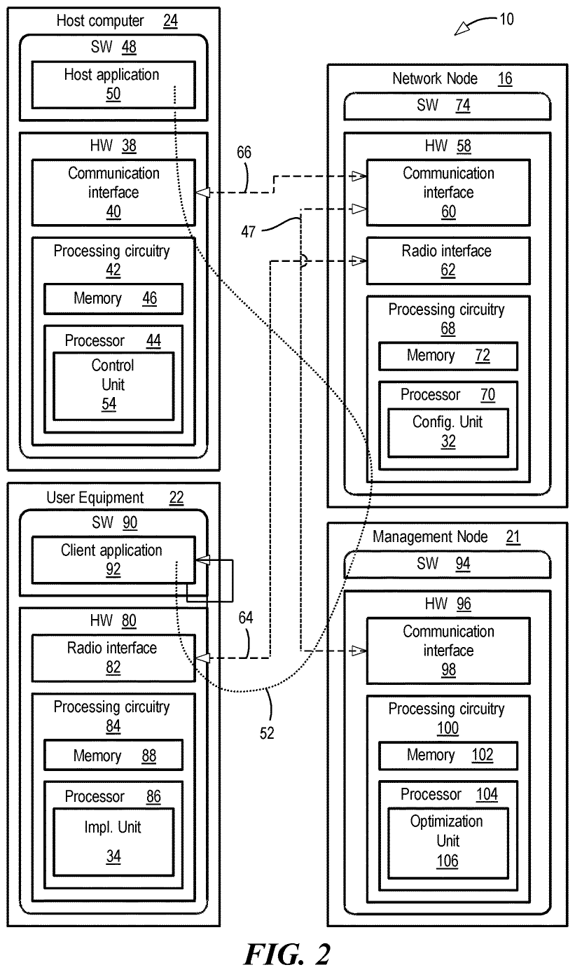

Example implementations, in accordance with an embodiment, of the UE 22, network node 16, management node 21, and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a UE 22 connecting via an OTT connection 52 terminating at the UE 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16, wireless device 22, and/or management node 21.

The communication system 10 further includes a network node 16 provided in a communication system 10 and including hardware 58 enabling it to communicate with the host computer 24 and with the UE 22. The hardware 58 may include a communication interface 60 for setting up and maintaining a wired or wireless connection with an interface of a different communication device of the communication system 10, as well as a radio interface 62 for setting up and maintaining at least a wireless connection 64 with a UE 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform one or more wireless device 22 functions described herein, including functions related to intelligent recommendation for intent orchestration in wireless networks.

The communication system 10 further includes the UE 22 already referred to. The UE 22 may have hardware 80 that may include a radio interface 82 configured to set up and maintain a wireless connection 64 with a network node 16 serving a coverage area 18 in which the UE 22 is currently located. The radio interface 82 may be formed as or may include, for example, one or more RF transmitters, one or more RF receivers, and/or one or more RF transceivers.

The hardware 80 of the UE 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the UE 22 may further comprise software 90, which is stored in, for example, memory 88 at the UE 22, or stored in external memory (e.g., database, storage array, network storage device, etc.) accessible by the UE 22. The software 90 may be executable by the processing circuitry 84. The software 90 may include a client application 92. The client application 92 may be operable to provide a service to a human or non-human user via the UE 22, with the support of the host computer 24. In the host computer 24, an executing host application 50 may communicate with the executing client application 92 via the OTT connection 52 terminating at the UE 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by UE 22. The processor 86 corresponds to one or more processors 86 for performing UE 22 functions described herein. The UE 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to UE 22. For example, the processing circuitry 84 of the wireless device 22 may include an implementation unit 34 configured to perform one or more wireless device 22 functions described herein, including functions related to intelligent recommendation for intent orchestration in wireless networks.

The communication system 10 includes a management node 21. The management node 21 includes hardware 96 enabling the management unit 21 to communicate with the one or more network nodes 16 and/or wireless devices 22. The hardware 96 may include a communication interface 98 for receiving and/or sending information (e.g., datasets corresponding to performance metrics, knowledge graphs and related configurations, machine learning models and related parameters, etc.) to/from one or more network nodes 16 via one or more wired and/or wireless connections 47.

In the embodiment shown, the hardware 96 of the management node 21 further includes processing circuitry 100. The processing circuitry 100 may include a processor 104 and a memory 102. In particular, in addition to or instead of a processor, such as a central processing unit and/or a graphics processing unit (GPU), and memory, the processing circuitry 100 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 104 may be configured to access (e.g., write to and/or read from) the memory 102, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the management node 21 further has software 94 stored internally in, for example, memory 102, or stored in external memory (e.g., database, storage array, network storage device, etc.) accessible by the network node 16 via an external connection. The software 94 may be executable by the processing circuitry 100. The processing circuitry 100 may be configured to control any of the methods and/or processes described herein and/or to cause such methods, and/or processes to be performed, e.g., by network node 16. Processor 104 corresponds to one or more processors 104 for performing management node 21 functions described herein. The memory 102 is configured to store data, programmatic software code and/or other information described herein. In some embodiments, the software 94 may include instructions that, when executed by the processor 104 and/or processing circuitry 100, causes the processor 104 and/or processing circuitry 100 to perform the processes described herein with respect to management node 21. For example, processing circuitry 100 of the management node 21 may include optimization unit 106 which is configured to perform one or more management node 21 functions disclosed herein, such as intelligent recommendation for intent orchestration in wireless networks.

In some embodiments, the inner workings of the network node 16, UE 22, management node 21, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the UE 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the UE 22, network node 16, and management node 21 is in accordance with the teachings of the embodiments described throughout this disclosure. One or more of the various embodiments improve the performance of OTT services provided to the UE 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and UE 22, in response to variations in the measurement results. The measurement procedure and/or the network functionality for reconfiguring the OTT connection 52 may be implemented in the software 48 of the host computer 24 or in the software 90 of the UE 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary UE signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the UE 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the UE 22, and/or preparing/terminating/maintaining/supporting/ending in receipt of a transmission from the UE 22.

In some embodiments, the host computer 24 includes processing circuitry 42 and a communication interface 40 that is configured to a communication interface 40 configured to receive user data originating from a transmission from a UE 22 to a network node 16. In some embodiments, the UE 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as configuration unit 32, implementation unit 34, and optimization unit 106 as being within a respective processor, it is contemplated that these units may be implemented such that a portion of the unit is stored in a corresponding memory within the processing circuitry. In other words, the units may be implemented in hardware or in a combination of hardware and software within the processing circuitry.

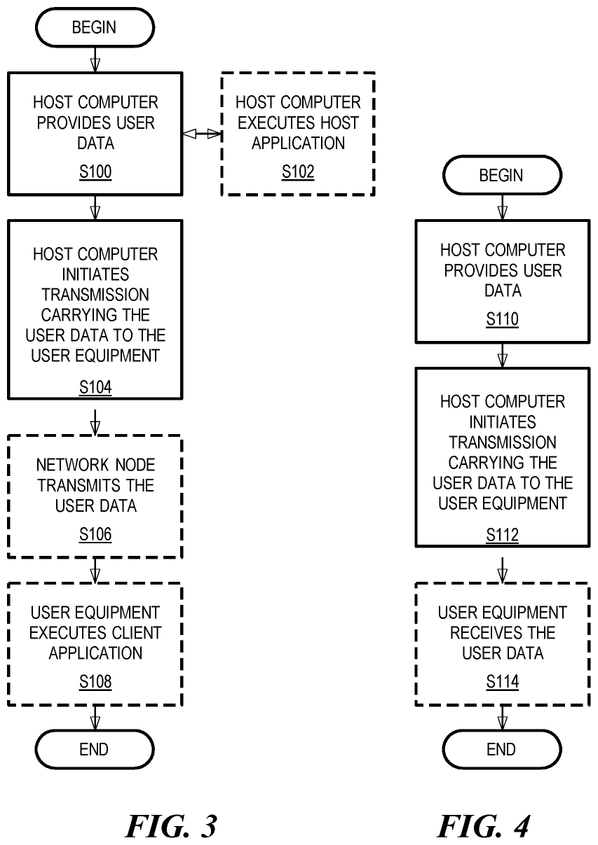

FIG. 3 is a flowchart illustrating an example method implemented in a communication system, such as, for example, the communication system of FIGS. 1 and 2, in accordance with one embodiment. The communication system may include a host computer 24, a network node 16 and a UE 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the UE 22 (Block S104). In an optional third step, the network node 16 transmits to the UE 22 the user data which was carried in the transmission that the host computer 24 initiated, in accordance with the teachings of the embodiments described throughout this disclosure (Block S106). In an optional fourth step, the UE 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a UE 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the UE 22 (Block S112). The transmission may pass via the network node 16, in accordance with the teachings of the embodiments described throughout this disclosure. In an optional third step, the UE 22 receives the user data carried in the transmission (Block S114).

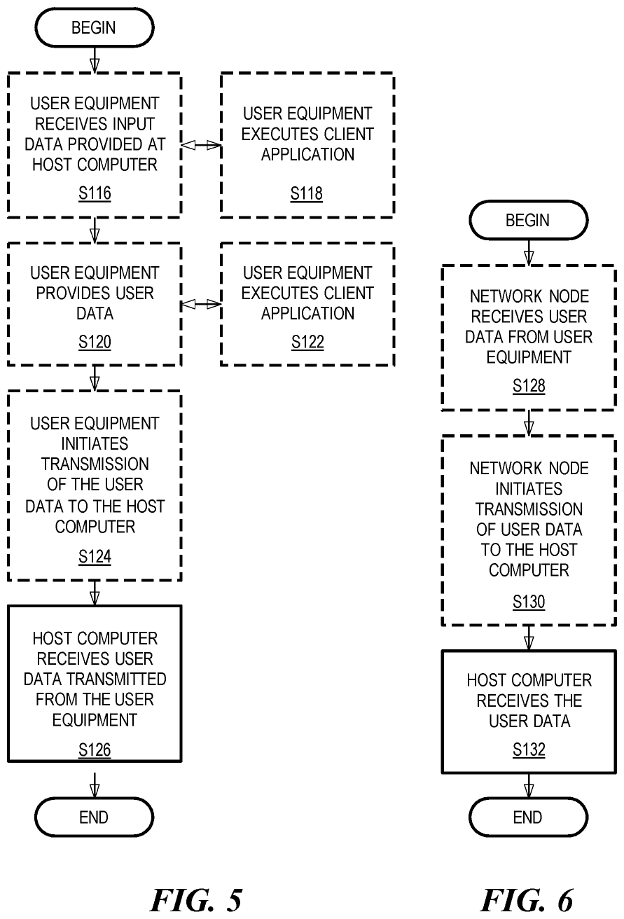

FIG. 5 is a flowchart illustrating an example method implemented in a communication system, such as, for example, the communication system of FIG. 1, in accordance with one embodiment. The communication system may include a host computer 24, a network node 16 and a UE 22, which may be those described with reference to FIGS. 1 and 2. In an optional first step of the method, the UE 22 receives input data provided by the host computer 24 (Block S116). In an optional substep of the first step, the UE 22 executes the client application 92, which provides the user data in reaction to the received input data provided by the host computer 24 (Block S118). Additionally or alternatively, in an optional second step, the UE 22 provides user data (Block S120). In an optional substep of the second step, the UE provides the user data by executing a client application, such as, for example, client application 92 (Block S122). In providing the user data, the executed client application 92 may further consider user input received from the user. Regardless of the specific manner in which the user data was provided, the UE 22 may initiate, in an optional third substep, transmission of the user data to the host computer 24 (Block S124). In a fourth step of the method, the host computer 24 receives the user data transmitted from the UE 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a UE 22, which may be those described with reference to FIGS. 1 and 2. In an optional first step of the method, in accordance with the teachings of the embodiments described throughout this disclosure, the network node 16 receives user data from the UE 22 (Block S128). In an optional second step, the network node 16 initiates transmission of the received user data to the host computer 24 (Block S130). In a third step, the host computer 24 receives the user data carried in the transmission initiated by the network node 16 (Block S132).

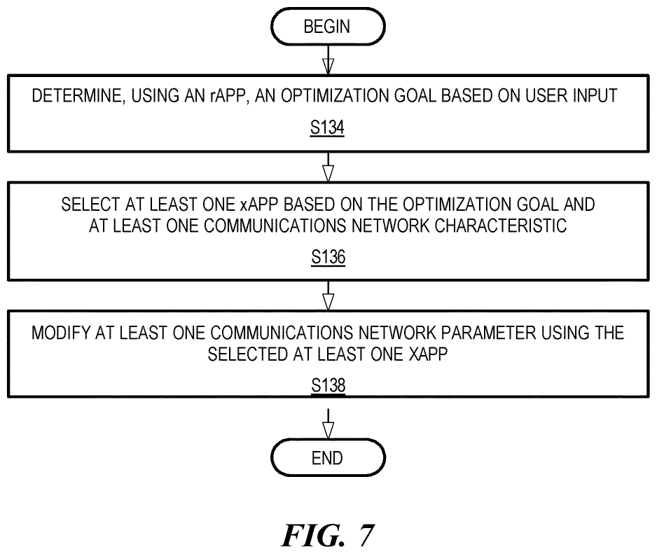

FIG. 7 is a flowchart of an example process in a management node 21 according to some embodiments of the present disclosure. One or more blocks described herein may be performed by one or more elements of management node 21, such as by one or more of processing circuitry 100 (including the optimization unit 106), processor 104, and/or communication interface 98. Management node 21 is configured to determine, using an rAPP, an optimization goal based on user input (Block S134). management node 21 is configured to select at least one xApp based on the optimization goal and at least one communications network characteristic (Block S136). Management node 16 is configured to modify at least one communications network parameter using the selected at least one xApp (Block S138).

In at least one embodiment, the xApp includes at least one machine learning, ML, functionality.

In at least one embodiment, the xApp is configured to optimize the at least one parameter based on at least one metric.

In at least one embodiment, the rApp is configured to use a hierarchical deep Q-learning (h-DQN) framework.

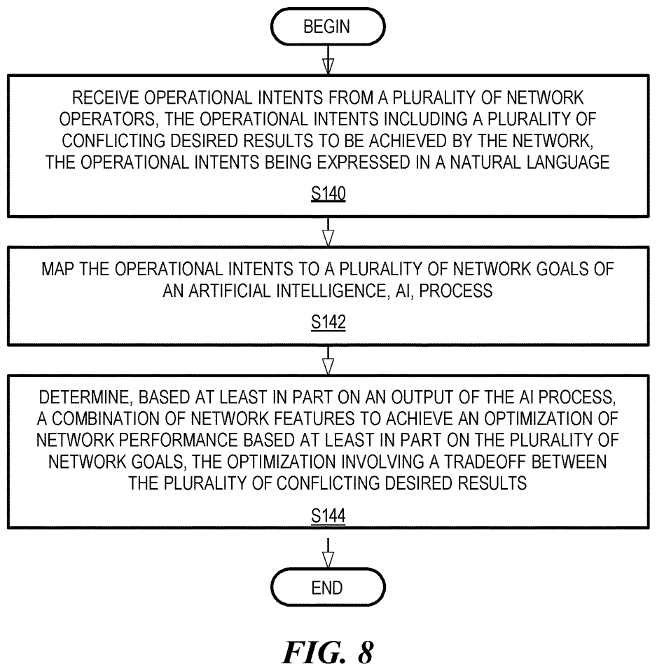

FIG. 8 is a flowchart of an example process in a network node 16 configured for intelligent recommendation for intent orchestration in wireless networks. The process may be performed by the hardware 58, including the radio interface 62, processing circuitry 68, including processor 70 and configuration unit 32. The process includes receiving operational intents from a plurality of network operators, the operational intents including a plurality of conflicting desired results to be achieved by the network, the operational intents being expressed in a natural language (Block S140). The method includes mapping the operational intents to a plurality of network goals of an artificial intelligence, AI, process (Block S142). The method also includes determining, based at least in part on an output of the AI process, a combination of network features to achieve an optimization of network performance network node (16) the plurality of network goals, the optimization involving a tradeoff between the plurality of conflicting desired results (Block S144).

According to this aspect, in some embodiments, the network goals include decreasing energy consumption compared to an existing energy consumption and increasing throughput compared to an existing throughput. In some embodiments, the method includes determining an expected performance from execution of the combination of network features and communicating the expected performance to at least one network operator of the plurality of network operators. In some embodiments, determining a combination of network features includes determining a combination of network features that results in a highest level of performance among different combinations of network features, as measured by at least one key performance indicator, KPI. In some embodiments, the at least one KPI is determined based at least in part on at least one of the received operational intents. In some embodiments, the method includes implementing the determined combination of network features. In some embodiments, determining the combination of network features is based at least in part on at least one of a traffic load ratio, a queue length of a base station and an indicator of quality of service, QoS, status. In some embodiments, determining the combination of network features is based at least in part on data collected from a plurality of base stations and stored in a database. In some embodiments, the database is populated with data obtained based at least in part on network performances associated with a plurality of combinations of network features. In some embodiments, determining the combination of network features includes training network application functions based at least in part on the network goals.

Having described the general process flow of arrangements of the disclosure and having provided examples of hardware and software arrangements for implementing the processes and functions of the disclosure, the sections below provide details and examples of arrangements for intelligent recommendation for intent orchestration in wireless networks. One or more wireless device 22 functions described below may be performed by one or more of processing circuitry 84, processor 86, implementation unit 34, etc. One or more network node 16 functions described below may be performed by one or more of processing circuitry 68, processor 70, configuration unit 32, etc. One or more management node functions described below may be performed by one or more of processing circuitry 100, processor 104, optimization unit 106, etc.

Implementations in an open radio access network (O-RAN) described herein should be understood to be an example. The teachings in accordance with the foregoing embodiments are not limited to implementations in radio access networks.

Some embodiments provide for handling multiple objectives provided by an operator, which may be formulated as an intent in a natural language. The operator input (which may be entered into, e.g., the management node 21, which may be implemented, e.g., as one or more O-RAN management entities), for example, may be aiming to decrease energy consumption and increase throughput. Yet, these two objectives might be in conflict during certain traffic loads and other conditions. Therefore, some of the goals of an intent might be partially fulfilled. For instance, if the operator intent is formulated as 40% energy savings+10% throughput increase, as a result of the developed recommendation system, the intent orchestrator could come up with a 20% increase in energy efficiency and a 15% throughput increase recommendation. In this assistive recommendation system (e.g., via the management node 21 and/or optimization unit 106), if the operator agrees with the recommended settings, then the parameters of the network functions may be optimized to achieve the target performance values. Furthermore, these recommendations may be fed into a recommender engine (which may be part of the management node 21 and/or optimization unit 106) where future optimization decisions may benefit from prior intents and the recommender outcomes. Thus, network configurations and performances achieved are recorded. Based on the data analytics gathered from the interactions of these functions in the system, a recommendation system is built (e.g., as part of the management node 21) that may provide recommendations regarding the best choice of the network function to have desired performance increase. The network functions may relate to, e.g., operation of one or more O-RAN components, such as but not limited to a network node 16 and/or wireless device 22.

Embodiments described herein relate to a recommendation system (e.g., as part of a management node 21) that may provide suggestions to the human operator responsible for configuring network parameters at the CSP side, acting as an assistive AI technology, and choosing appropriate network functions and configurations that may be used to reach the desired performance and avoid conflicts and ping pong effects.

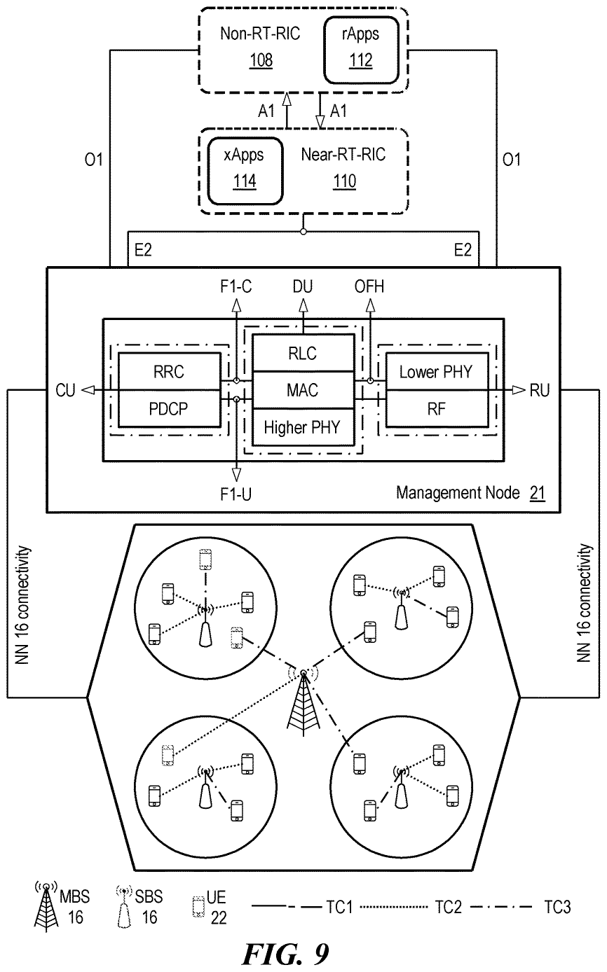

The system model of FIG. 9 is used to facilitate understanding of the disclosure and is based on the O-RAN architecture. O-RAN is suitable for AI-based RAN optimization due to the concept of RAN intelligent controller (RIC). RIC is divided into non real-time RIC (non-RT-RIC) and near real-time RIC (near-RT-RIC). Both of these RIC platforms may host rApps and xApps which are control and optimization applications operating at different time scales. Previously discussed network functions including the recommendation system (e.g., as part of the management node 21) fall into the category of these RIC applications. Near-RT-RIC may host any number of xApps. rApp works as an input panel for the network operator, and it may convert these inputs as goals to be optimized. The second rApp works as the recommendation system (e.g., as part of the management node 21). There are three control loops in the system. The first one is a non-real-time control loop directly associated with the non-RT-RIC with a latency of much more than 1s. The near-RT-RIC closes the control loop on a time scale of more than 10 ms and less than 1 s. Within this time frame, the xApps operate, generate control actions, and collect feedback information. The lowest in the hierarchy of the system model is the network model having a multi-RAT environment.

User Interface rApp

At least one embodiment includes an rApp, which may be directly connected to the user panel (which may be, e.g., an input device, e.g., a UE 22, that is part of and/or in communication with the management node 21) where the operator may provide input to the system (e.g., as part of the management node 21). The user input may be in the form of a natural language such as “increase the amount of throughput by 20%.” The rApp may have a hierarchical deep Q-learning (h-DQN) framework, in which the meta controller takes the input as a goal, observes the state in the environment (different traffic types will be used as states), and provides both the goal and states to the controller in near-RT-RIC having a bundle of xApps. The controller takes the action of selecting an xApp. The selected xApp works on the live network to perform optimization. Based on whether or not the selection of the xApp has led to desired performance, intrinsic and extrinsic rewards are generated. The rApp may work as a management tool for xApps and an input panel for the network operator. Selection of the xApps and network configurations of those certain time stamps along with the performance improvement record may be stored in a database (e.g., as part of the management node 21 or in communication therewith).

Recommendation rApp

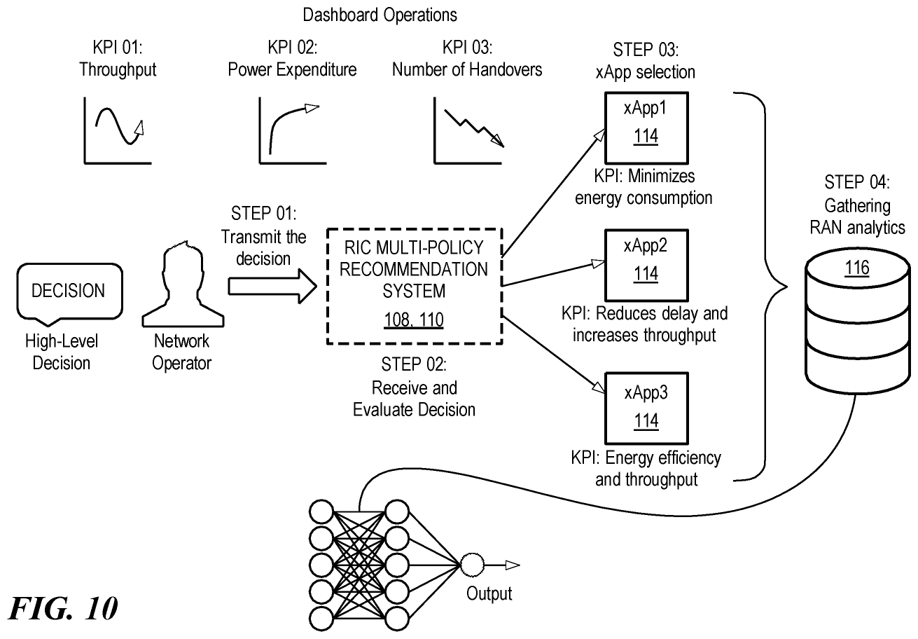

Some embodiments include a recommender rApp, which works on the collected RAN analytics having multiple types of features obtained from the real-time network to perform recommendations regarding which xApp is most likely to provide the desired performance based on the network operator's input (e.g., into the management node 21). This recommendation part may play a role when there are many xApps, and they are supporting a live network to keep the performance optimized for both the user side and operator side of the industry. A database created using the RAN analytics may be updated as needed, since the network situations may change. However, the recommendation system (e.g., management node 21) may not depend on the underlying reinforcement learning algorithms used in the xApps/rApps. Once the data is recorded in the database to be used as a dataset, it may function independently. Features may include traffic load ratio, the queue length of the BSs, binary variable if the QoS has been maintained or intended performance increase has been achieved, etc. Using the collected dataset, the recommendation system may also predict network configurations leading to better performance working as a reference for the network operator. This is shown in FIG. 10, which depicts an example recommendation system (e.g., as part of the management node 21) according to some embodiments of the present disclosure.

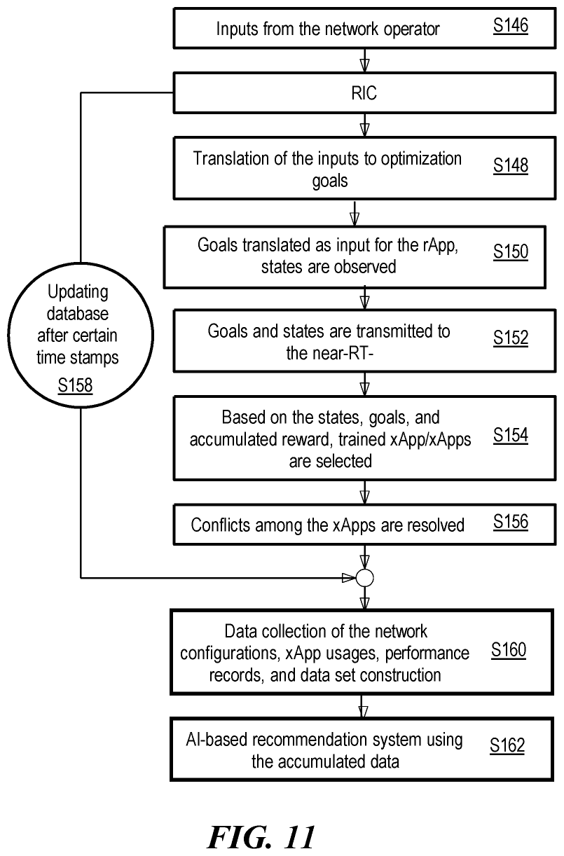

FIG. 11 depicts another example process according to some embodiments of the present disclosure that may be performed by management node 21 in whole or part, such as by optimization unit 106 and/or communication interface 98 and/or processing circuitry 100.

A network operator may provide input to the system 10 (e.g., via the management node 21) after viewing the dashboard regarding which performance metric is to be improved (Block S146).

The decision will be provided to the RIC (108, 110). The input may be translated as the optimization goal for the algorithm running in the system (Block S148). Goals may be translated as input for the rApp and states are observed (Block S150). Goals and states may be transmitted to the near-RT (Block S152).

Based on the goal and observed states, xApps may be selected by the controller in the near-RT-RIC (Block S154). xApps with their own ML functionalities may optimize network performances for different metrics. Conflicts among xApps may need to be resolved (Block S156).

The database may be updated, e.g., by the RIC, after certain time stamps (Block S158).

Running this whole process multiple times over time may allow for collection of data (e.g., network configurations, xApp usages, performance records, and data set construction) in the database of the non-RT-RIC having multiple features (Block S160). The dataset (i.e., accumulated data) may be used to configure a recommendation system (e.g., as part of the management node 21) that would provide the recommendation regarding which xApp or network configuration is to be selected for a particular kind of performance increase (Block S162).

Some examples may include one or more of the following:

Example A1. A management node in a communication network, the management node configured to, and/or comprising a radio interface and/or comprising processing circuitry configured to:
determine, using an rAPP, an optimization goal based on user input;
select at least one xApp based on the optimization goal and at least one communications network characteristic; and
modify at least one communication network parameter using the selected at least one xApp.

Example A2. The management node of Example A1, wherein the xApp comprises at least one machine learning, ML, functionality.

Example A3. The management node of Example A1, wherein the xApp is configured to optimize the at least one parameter based on at least one metric.

Example A4. The management node of Example A1, wherein the rApp is configured to use a hierarchical deep Q-learning (h-DQN) framework.

Example B1. A method implemented in a management node of a communication network, the method comprising
determining, using an rAPP, an optimization goal based on user input;
selecting at least one xApp based on the optimization goal and at least one communications network characteristic; and
modifying at least one communications network parameter using the selected at least one xApp.

Example B2. The method of Example B1, wherein the xApp comprises at least one machine learning, ML, functionality.

Example B3. The method of Example B1, wherein the xApp is configured to optimize the at least one parameter based on at least one metric.

Example B4. The method of Example B1, wherein the rApp is configured to use a hierarchical deep Q-learning (h-DQN) framework.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviations | Explanations |
|---|---|
| 5G | Fifth generation |
| BS | Base station |
| CSP | Communications service provider |
| h-DQN | Hierarchical deep reinforcement learning |
| KPI | Key performance indicator |
| LTE | Long-term evolution |
| Multi-RAT | Multiple radio access technology |
| Non-RT-RIC | Non-real time-RIC |
| NR | New radio |
| NSA | Non-stand-alone |
| O-RAN | Open RAN |
| QoS | Quality of service |
| RAN | Radio access network |
| RIC | RAN intelligent controller |
| UE | User equipment |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to control a network for communications with a plurality of user equipments, UEs, the method comprising:
receiving operational intents from a plurality of network operators, the operational intents including a plurality of conflicting desired results to be achieved by the network, the operational intents being expressed in a natural language;
mapping the operational intents to a plurality of network goals of an artificial intelligence, AI, process; and
determining, based at least in part on an output of the AI process, a combination of network features to achieve an optimization of network performance network node the plurality of network goals, the optimization involving a tradeoff between the plurality of conflicting desired results.

2. The method of claim 1, wherein the network goals include decreasing energy consumption compared to an existing energy consumption and increasing throughput compared to an existing throughput.

3. The method of claim 1, further comprising determining an expected performance from execution of the combination of network features and communicating the expected performance to at least one network operator of the plurality of network operators.

4. The method of claim 3, wherein determining a combination of network features includes determining a combination of network features that results in a highest level of performance among different combinations of network features, as measured by at least one key performance indicator, KPI.

5. The method of claim 4, wherein the at least one KPI is determined based at least in part on at least one of the received operational intents.

6. (canceled)

7. (canceled)

8. The method of claim 1, wherein determining the combination of network features is based at least in part on data collected from a plurality of base stations and stored in a database.

9. The method of claim 8, wherein the database is populated with data obtained based at least in part on network performances associated with a plurality of combinations of network features.

10. (canceled)

11. A network node configured control a network for communications with a plurality of user equipments, UEs, the network node configured to:
receive operational intents from a plurality of network operators, the operational intents including a plurality of conflicting desired results to be achieved by the network, the operational intents being expressed in a natural language;
map the operational intents to a plurality of network goals of an artificial intelligence, AI, process; and
determine, based at least in part on an output of the AI process, a combination of network features to achieve an optimization of network performance network node the plurality of network goals, the optimization involving a tradeoff between the plurality of conflicting desired results.

12. The network node of claim 11, wherein the network goals include decreasing energy consumption compared to an existing energy consumption and increasing throughput compared to an existing throughput.

13. The network node of claim 11, wherein the network node is configured to determine an expected performance from execution of the combination of network features and communicating the expected performance to at least one network operator of the plurality of network operators.

14. The network node of claim 13, wherein determining a combination of network features includes determining a combination of network features that results in a highest level of performance among different combinations of network features, as measured by at least one key performance indicator, KPI.

15. The network node of claim 14, wherein the at least one KPI is determined based at least in part on at least one of the received operational intents.

16. (canceled)

17. (canceled)

18. The network node of claim 11, wherein determining the combination of network features is based at least in part on data collected from a plurality of base stations and stored in a database.

19. The network node of claim 18, wherein the database is populated with data obtained based at least in part on network performances associated with a plurality of combinations of network features.

20. (canceled)

21. The method of claim 2, further comprising determining an expected performance from execution of the combination of network features and communicating the expected performance to at least one network operator of the plurality of network operators.

22. The method of claim 21, wherein determining a combination of network features includes determining a combination of network features that results in a highest level of performance among different combinations of network features, as measured by at least one key performance indicator, KPI.

23. The method of claim 22, wherein the at least one KPI is determined based at least in part on at least one of the received operational intents.

24. The method of claim 2, wherein determining the combination of network features is based at least in part on data collected from a plurality of base stations and stored in a database.

25. The method of claim 24, wherein the database is populated with data obtained based at least in part on network

26. The network node of claim 12, wherein the network node is configured to determine an expected performance from execution of the combination of network features and communicating the expected performance to at least one network operator of the plurality of network operators.
